(19) United States
(12) Patent Application Publication
(10) Pub. No.: US 2013/0260248 A1
(43) Pub. Date: Oct. 3, 2013

(54) ACTIVE MATERIAL AND LITHIUM ION SECONDARY BATTERY

(71) Applicant: TDK CORPORATION, Tokyo (JP)

(72) Inventors: Hideaki SEKI, Tokyo (JP); Tomohiko KATO, Tokyo (JP); Hirofumi NAKANO, Tokyo (JP); Atsushi SANO, Tokyo (JP)

(73) Assignee: TDK CORPORATION, Tokyo (JP)

(21) Appl. No.: 13/846,499

(22) Filed: Mar. 18, 2013

(30) Foreign Application Priority Data
Mar. 27, 2012 (JP) 2012-070940

(51) Int. Cl. H01M 4/505; H01M 4/525

(52) U.S. Cl. CPC H01M 4/505; H01M 4/525
USPC 429/221; 429/223

(57) ABSTRACT

An active material has a layered structure and a composition represented by the following formula (1) Li_{y}NiₐCo_{b}Mn_{c}M_{d}Oₓ . . . (1), wherein M is at least one selected from Al, Si, Zr, Ti, Fe, Mg, Nb, Ba and V, and a, b, c, d, x and y satisfy 1.9≦(a+b+c+d+y)≦2.1, 1.0<y≦1.3, 0<a≦0.3, 0<b≦0.25, 0.3≦c≦0.7, 0≦d≦0.1, and 1.9≦x≦2.1. The active material has a ratio of the half width FWHM₀₀₃ of a diffraction peak at a (003)-plane to the half width FWHM₁₀₄ of a diffraction peak at a (104)-plane represented by the formula (2) FWHM₀₀₃/FWHM₁₀₄≦0.57 . . . (2), and an average primary particle diameter of 0.2 to 0.5 μm.

### CROSS-REFERENCE TO RELATED APPLICATION

This application is based on Japanese Patent Application No. 2012-070940 filed with the Japan Patent Office on Mar. 27, 2012, the entire content of which is hereby incorporated by reference.

### BACKGROUND

1. Technical Field

The present disclosure relates to an active material and a lithium-ion secondary battery.

2. Related Art

In recent years, the spread of various electric vehicles has been expected to solve environmental and energy problems. For an on-vehicle power source such as a motor driving power source, which is the key for practical application of such electric vehicles, the development of lithium ion secondary batteries has been extensively conducted. When the lithium ion secondary batteries have higher performance and lower prices, the batteries will widely spread as the on-vehicle power source. Moreover, a higher-energy lithium-ion secondary battery has been desired for making the mileage per charge of an electric vehicle as long as that of a gasoline-powered vehicle.

Increasing the amount of power per unit mass of each of the positive and negative electrodes leads to an increase in energy density of the electrode. A so-called solid-solution positive electrode has been investigated as a positive electrode material (active material for a positive electrode) that can increase the amount of power storage. Above all, a solid solution including electrochemically inactive layered Li₂MnO₃ and electrochemically active layered LiAO₂ (A represents a transition metal such as Co or Ni) has been expected as a candidate for a high-capacity positive electrode material that can exhibit a high electric capacity of more than 200 mAh/g (see JP-A-9-55211).

### SUMMARY

An active material has a layered structure and a composition represented by the formula (1) below. The active material has a ratio of the half width FWHM₀₀₃ of a diffraction peak at a (003)-plane to the half width FWHM₁₀₄ of a diffraction peak at a (104)-plane represented by the formula (2) below, where both the peaks are obtained by X-ray powder diffraction, and an average primary particle diameter of 0.2 μm to 0.5 μmm;

Li_{y}NiₐCo_{b}Mn_{c}M_{d}Oₓ (1)

[wherein the element M is at least one element selected from the group consisting of Al, Si, Zr, Ti, Fe, Mg, Nb, Ba and V, and a, b, c, d, x and y satisfy the following formulae: 1.9≦(a+b+c+d+y)≦2.1, 1.0<y≦1.3, 0<a≦0.3, 0<b≦0.25, 0.3≦c≦0.7, 0≦d≦0.1, and 1.9≦x≦2.1], and

FWHM₀₀₃/FWHM₁₀₄≦0.57 (2).

### BRIEF DESCRIPTION OF DRAWINGS

FIG. 1 is a schematic cross-sectional view of a lithium-ion secondary battery including a positive electrode active material layer containing an active material formed from a precursor according to an embodiment of the present disclosure;

FIG. 2 is an X-ray diffraction measurement diagram of an active material according to Example 1;

FIG. 3 is a photograph of the active material according to Example 1, which is taken using a scanning electron microscope (SEM);

FIG. 4 is a photograph of an active material according to Comparative Example 1, which is taken using a scanning electron microscope (SEM);

FIG. 5 is a photograph of an active material according to Comparative Example 2, which is taken using a scanning electron microscope (SEM); and

FIG. 6 is an X-ray diffraction measurement diagram of an active material according to Comparative Example 3.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The solid-solution positive electrode with Li₂MnO₃ described in JP-A-9-55211 has a poor cyclic characteristic in spite of having a high initial discharge capacity. The discharge capacity of this positive electrode therefore deteriorates due to repetition of charging and discharging. In the positive electrode active material according to JP-A-2009-059711, on the other hand, the half widths of respective peaks obtained by X-ray powder diffraction on this material fall within a predetermined range. In this document, however, such a positive electrode active material has a poor discharge capacity in spite of having an excellent cycle characteristic. Further, JP-A-2010-278015 describes that the half widths of respective peaks obtained by X-ray powder diffraction should be within a particular range. In this document, however, the positive electrode active material has a poor cycle characteristic in spite of having a relatively high initial discharge capacity.

An object of the present disclosure is to provide an active material with a high discharge capacity and an excellent charging/discharging cycle characteristic, and to provide a lithium-ion secondary battery containing this active material.

An active material according to the present disclosure (the present active material) has a layered structure and has a composition represented by the formula (1) below. In this active material, the ratio of the half width FWHM₀₀₃ of a diffraction peak at a (003)-plane to the half width FWHM₁₀₄ of a diffraction peak at a (104)-plane, both the peaks being obtained by X-ray powder diffraction, is represented by the formula (2) below, and the average primary particle diameter is in the range of 0.2 μm to 0.5 μm.

Li_{y}NiₐCo_{b}Mn_{c}M_{d}Oₓ (1)

[wherein the element M is at least one element selected from the group consisting of Al, Si, Zr, Ti, Fe, Mg, Nb, Ba and V, and a, b, c, d, x and y satisfy the following formulae: 1.9≦(a+b+d+y)≦2.1, 1.0<y≦1.3, 0<a≦0.3, 0<b≦0.25, 0.3≦c≦0.7, 0≦d≦0.1, and 1.9≦x≦2.1.]

FWHM₀₀₃/FWHM₁₀₄≦0.57 (2)

The ratio FWHM₀₀₃/FWHM₁₀₄ corresponds to the thickness of the active material with the layered structure in a c-axis direction. When FWHM₀₀₃<FWHM₁₀₄ holds, or when the value of FWHM₀₀₃ is relatively small, the thickness of crystal of the active material in the c-axis direction is large. Moreover, the average primary particle diameter of the active material is closely related to the capacity of the battery. The present active material is thicker along the c-axis direction. Therefore, the intercalation and deintercalation of lithium with respect to the present active material are performed smoothly. Moreover, since the average primary particle diameter of the present active material is small, the surface area of the primary particles is large. Thus, it is considered that the present active material has high discharge capacity and an excellent cycle characteristic.

In the present active material, the element M in the formula (1) is preferably Fe or V and d preferably satisfies 0<d≦0.1.

A lithium-ion secondary battery according to the present disclosure includes a positive electrode including a positive electrode current collector and a positive electrode active material layer containing a positive electrode active material, a negative electrode including a negative electrode current collector and a negative electrode active material layer containing a negative electrode active material, a separator disposed between the positive electrode active material layer and the negative electrode active material layer, and an electrolyte in contact with the negative electrode, the positive electrode, and the separator. The positive electrode active material preferably contains the present active material.

In this lithium-ion secondary battery, the positive electrode active material layer contains the present active material. Therefore, this lithium-ion secondary battery has high discharge capacity and an excellent cycle characteristic.

According to the present disclosure, an active material having high discharge capacity and an excellent charging/discharging cycle characteristic, and a lithium-ion secondary battery can be provided.

An active material (present active material), a manufacturing method for the present active material, and a lithium-ion secondary battery containing the present active material according to an embodiment of the present disclosure are hereinafter described. Note that the present disclosure is not limited to the embodiment described below.

### (Active Material)

The present active material has a layered structure and has a composition represented by the formula (1) below. The ratio of the half width FWHM₀₀₃ of a diffraction peak at the (003)-plane to the half width FWHM₀₀₄ of a diffraction peak at the (104)-plane, both the peaks being obtained by X-ray powder diffraction for the present active material, is represented by the formula (2) below, and the primary particle diameter of the present active material is in the range of 0.2 μm to 0.5 μm.

Li_{y}NiₐCo_{b}Mn_{c}M_{d}Oₓ (1)

[wherein the element M is at least one element selected from the group consisting of Al, Si, Zr, Ti, Fe, Mg, Nb, Ba and V, and a, b, c, d, x and y satisfy the following formulae: 1.9≦(a+b+c+d+y)≦2.1, 1.0<y≦1.3, 0<a≦0.3, 0<b≦0.25, 0.3≦c≦0.7, 0≦d≦0.1, and 1.9≦x≦2.1].

FWHM₀₀₃/FWHM₁₀₄≦0.57 (2)

The layered structure described herein is generally represented by LiAO₂ (A represents a transition metal such as Co, Ni, or Mn). In this layered structure, a lithium layer, a transition metal layer, and an oxygen layer are stacked in one direction. Typical layered structures include a structure of α-NaFeO₂ type, such as LiCoO₂ and LiNiO₂. These are rhombohedral materials, and belong to a space group R(-3)m from their symmetry. LiMnO₂ is an orthorhombic material, and belongs to a space group Pm2m from its symmetry. Li₂MnO₃ can also be represented by Li[Li_{1/3}Mn_{2/3}]O₂, and belongs to a space group C2/m of a monoclinic system. Li₂MnO₃ is a layered compound in which a Li layer, a [Li_{1/3}Mn_{2/3}] layer, and an oxygen layer are stacked. The present active material is a solid solution of a lithium transition metal composite oxide, which is represented by LiAO₂. In the present active material, the metal element occupying the transition metal site may be Li.

### (Composition Analysis)

Whether the active material has the layered structure or not and whether the active material has the composition represented by the formula (1) or not can be known by an inductively coupled plasma method (ICP method).

### (Half Width)

The half width is the full width at half maximum abbreviated as FWHM and can be obtained from the results of X-ray powder diffraction. For obtaining the half widths FWHM₀₀₃ and FWHM₀₀₄, first, the peak patterns of the active material (X-ray powder diffraction diagram) are acquired according to the X-ray powder diffraction in which a CuKα tube is used. Of the obtained peak patterns, the diffraction peak at the (003)-plane corresponding to 2θ=18.6°±1° and the diffraction peak at the (104)-plane corresponding to 2θ=44.5°±1° are examined. Then, the full widths at half maximum of these diffraction peaks, FWHM₀₀₃ and FWHM₁₀₄, are calculated.

The ratio of FWHM₀₀₃ to FWHM₁₀₄ (FWHM₀₀₃/FWHM₁₀₄) is preferably 0.57 or less. This ratio may also be referred to as a peak half width ratio below. The half width FWHM₀₀₃ of the diffraction peak at the (003)-plane corresponding to 2θ=18.6°±1° is preferably 0.13 or less. Moreover, the half width FWHM₀₁₀ of the diffraction peak at the (010)-plane corresponding to 2θ=36.8°±1° is preferably 0.15 or less. Furthermore, the half width FWHM₁₀₄ of the diffraction peak at the (104)-plane corresponding to 2θ=44.5°±1° is preferably 0.20 or less. By having each half width in the above range, the active material has high discharge capacity.

### (Primary Particle Diameter)

A method of calculating the primary particle diameter of the active material is as follows. First, the particles of the active material are observed with a scanning electron microscope (SEM). Then, 500 or more primary particles are photographed. Based on the obtained images, the area of each particle is calculated. Then, the results of calculation are converted into diameters of equivalent circles, thereby leading the particle diameters. The average value of the particle diameters is taken as the primary particle diameter (average primary particle diameter). Note that it has already been made clear that the discharge capacity of the active material increases as the primary particle diameter is smaller and that the cycle characteristic of the active material improves as the primary particle diameter is larger. The primary particle diameter is preferably in the range of 0.2 to 0.5 μm. For achieving well-balanced discharge capacity and cycle characteristic, the primary particle diameter is preferably in the range of 0.3 to 0.4 μm.

### (Manufacturing Method For The Present Active Material)

### (Production Of Precursor)

A precursor of the present active material is prepared first for producing the present active material. A precursor according to this embodiment (present precursor) is prepared so as to satisfy the formula (1) below and to have the same composition as the present active material.

Li_{y}NiₐCo_{b}Mn_{c}M_{d}Oₓ (1)

[wherein the element M is at least one element selected from the group consisting of Al, Si, Zr, Ti, Fe, Mg, Nb, Ba and V, and a, b, e, d, x and y satisfy the following formulae: 1.95≦(a+b+c+d+y)≦2.1, 1.0<y≦1.3, 0<a≦0.3, 0<b≦0.25, 0.3≦c≦0.7, 0≦d≦0.1, and 1.9≦x≦2.1].

The present precursor includes, for example, Li, Ni, Co, Mn, M, and O. In a manner similar to the above composition represented by the above formula (1), the present precursor is a material whose molar ratio among Li, Ni, Co, Mn, M, and O is y:a:b:c:d:x. In the production of the present precursor, compounds of Li, Ni, Co, Mn, and M (for example, salts) and a compound containing O are mixed so as to satisfy the above molar ratio. The present precursor is a mixture obtained by mixing, and further heating as necessary, these compounds. One of the compounds contained in the present precursor may include a plurality of elements selected from the group consisting of Li, Ni, Co, Mn, M, and O. The molar ratio of O in the present precursor changes depending on the calcining condition (for example, atmosphere or temperature) for the present precursor. Therefore, the molar ratio of O in the present precursor may be out of the above range of x.

The present precursor is obtained by mixing the following compounds so as to satisfy the molar ratio indicated in the above formula (1). Specifically, a procedure such as pulverizing and mixing, thermal decomposition and mixing, precipitation reaction, or hydrolysis can be employed to produce the present precursor out of the compounds below.

Lithium compound: lithium acetate dihydrate, lithium hydroxide monohydrate, lithium carbonate, lithium nitrate, lithium chloride, or the like.

Nickel compound: nickel acetate tetrahydrate, nickel sulfate hexahydrate, nickel nitrate hexahydrate, nickel chloride hexahydrate, or the like.

Cobalt compound: cobalt acetate tetrahydrate, cobalt sulfate heptahydrate, cobalt nitrate hexahydrate, cobalt chloride hexahydrate, or the like.

Manganese compound: manganese acetate tetrahydrate, manganese sulfate pentahydrate, manganese nitrate hexahydrate, manganese chloride tetrahydrate, or the like.

M compounds: Al source, Si source, Zr source, Ti source, Fe source, Mg source, Nb source, Ba source, or V source (oxide, fluoride, or the like). For example, aluminum nitrate nonahydrate, aluminum fluoride, iron sulfate heptahydrate, silicon dioxide, zirconium nitrate oxide dihydrate, titanium sulfate hydrate, magnesium nitrate hexahydrate, niobium oxide, barium carbonate, and vanadium oxide. A preferable method for manufacturing the present precursor includes mixing a liquid raw material obtained by dissolving a Mn compound, a Ni compound, a Co compound, and a Li compound in a solvent (e.g., water) with a suitable additive, and stirring the mixture, and subsequently heating the mixed and stirred raw material. By drying the product obtained by the heating, the composite oxide (the present precursor), which has a uniform composition and is easily crystallized at low temperature, can be easily produced.

A raw-material mixture can be obtained by preparing the solvent in which the above compounds are dissolved by adding a complexing agent to the solvent. The present precursor can be obtained by mixing, stirring, and heating this raw-material mixture. For adjusting the pH, an acid may be added to the raw-material mixture as necessary. The kind of the complexing agent is not limited; however, the complexing agent is preferably, for example, citric acid, malic acid, tartaric acid, or lactic acid in consideration of the accessibility and cost.

The specific surface area of the present precursor is preferably in the range of 0.5 to 6.0 m²/g. Thus, the crystallization (calcining) of the present precursor easily progresses. As a result, the charging/discharging cycle durability (cycle characteristic) of a lithium-ion secondary battery containing the present active material is easily improved. When the specific surface area of the present precursor is smaller than 0.5 m²/g, the particle diameter of the present precursor (the present active material) after the calcining (the particle diameter of the lithium compound) becomes larger. Accordingly, the composition distribution of the present active material to be obtained finally tends to be non-uniform. When the specific surface area of the present precursor is larger than 6.0 m²/g, the amount of water absorption of the present precursor becomes larger. Accordingly, the calcining step for the present precursor becomes difficult. When the amount of water absorption of the present precursor is large, a dry environment is used, which increases the cost for producing the present active material. Note that the specific surface area can be measured by a known BET powder specific surface area measurement apparatus. When the specific surface area of the present precursor is out of the above range, the temperature at which the present precursor is crystallized tends to be higher. The specific surface area of the present precursor can be adjusted by a method of pulverizing, a pulverizing medium, a pulverizing time, or the like.

### (Calcining of the Precursor)

Next, the present precursor is subjected to calcining. Calcining the present precursor results in a solid solution of the lithium compound (present active material) having a layered structure and represented by the following formula (1):

Li_{y}NiₐCo_{b}Mn_{c}M_{d}Oₓ (1)

[wherein the element M is at least one element selected from the group consisting of Al, Si, Zr, Ti, Fe, Mg, Nb, Ba and V, and a, b, e, d, x and y satisfy the following formulae: 1.9≦(a+b+c+d+y)≦2.1, 1.0<y≦1.3, 0<a≦0.3, 0 <b≦0.25, 0.3≦c≦0.7, 0≦d≦0.1, and 1.9<x≦2.1].

The calcining temperature for the present precursor is preferably 800 to 1100° C., more preferably 850 to 1050° C. When the calcining temperature of the present precursor is less than 500° C., the calcining reaction of the present precursor does not progress sufficiently and the crystallinity of the lithium compound obtained therefore becomes low. When the calcining temperature of the present precursor is more than 1100° C., the amount of evaporated Li becomes larger. This results in high tendency of generating the lithium compound having a composition lacking lithium. Moreover, when the calcining temperature of the present precursor is more than 1100° C., primary particles are easily calcined and grown, thereby easily reducing the specific surface area of the resulting lithium compound.

The calcining atmosphere for the present precursor preferably includes oxygen. Specifically, the calcining atmosphere includes, for example, a mixture gas including an inert gas and oxygen, and an atmosphere including oxygen such as air. The calcining time for the present precursor is preferably three hours or more, and more preferably five hours or more.

For obtaining the powder of the active material having desired particle diameter and shape, a pulverizer or classifier is used. For example, a mortar, a ball mill, a bead mill, a sand mill, a vibration ball mill, a planetary ball mill, a jet mill, a counter jet mill, a swirling air flow type jet mill, or a sieve is used. As a method of pulverizing, a wet pulverizing method in which water or an organic solvent such as hexane is used may be employed. The classifying method is not particularly limited. Depending on the purpose, a sieve, a pneumatic classifier, or the like is used for dry classification or wet classification.

(Lithium Ion Secondary battery)

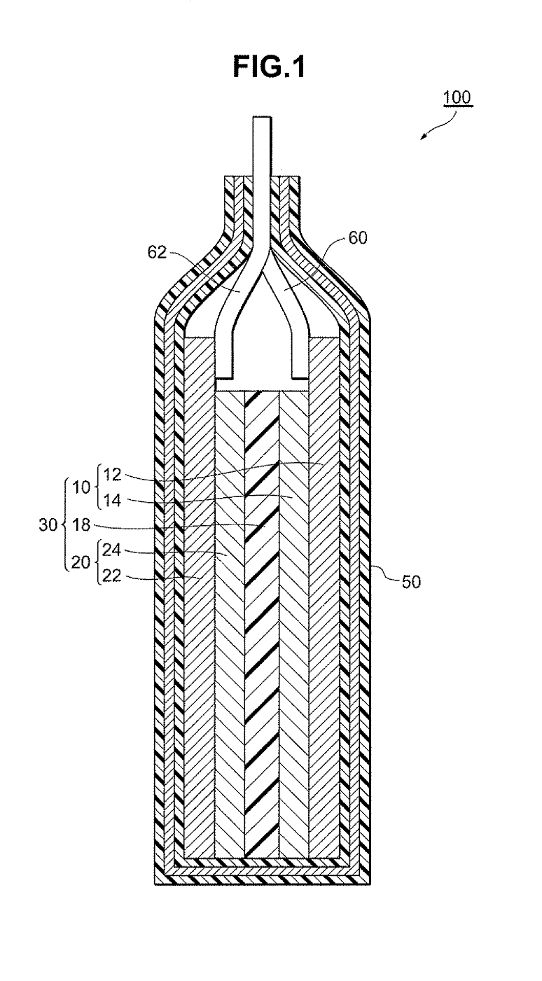

FIG. 1 is a schematic cross-sectional view of a lithium-ion secondary battery 100 containing the present active material. As depicted in this drawing, the lithium-ion secondary battery 100 includes a power generating element 30, a nonaqueous electrolyte containing lithium ions, a case 50, a negative electrode lead 62, and a positive electrode lead 60. The power generating element 30 includes a plate-like positive electrode 10, a plate-like negative electrode 20, and a plate-like separator 18. The negative electrode 20 and the positive electrode 10 face each other. The separator 18 is disposed adjacent to, and between the negative electrode 20 and the positive electrode 10. The case 50 houses the power generating element 30 and the nonaqueous electrolyte in a sealed state. One end of the negative electrode lead 62 is electrically connected to the negative electrode 20. The other end of the negative electrode lead 62 protrudes out of the case. One end of the positive electrode lead 60 is electrically connected to the positive electrode 10. The other end of the positive electrode lead 60 protrudes out of the case.

The negative electrode 20 includes a negative electrode current collector 22, and a negative electrode active material layer 24 formed on the negative electrode current collector 22. The positive electrode 10 includes a positive electrode current collector 12, and a positive electrode active material layer 14 formed on the positive electrode current collector 12. The separator 18 is disposed between the negative electrode active material layer 24 and the positive electrode active material layer 14.

The positive electrode active material contained in the positive electrode active material layer 14 is the present active material described above. In other words, this positive electrode active material has the layered structure. This positive electrode active material has the composition represented by the formula (1) below. The ratio of the half width FWHM₀₀₃ of the diffraction peak at the (003)-plane to the half width FWHM₁₀₄ of the diffraction peak at the (104)-plane, both the peaks being obtained by the X-ray powder diffraction for this positive electrode active material, is represented by the formula (2) below, and the primary particle diameter is in the range of 0.2 μm to 0.5 μm.

Li_{y}NiₐCo_{b}Mn_{c}M_{d}Oₓ (1)

[wherein the element M is at least one element selected from the group consisting of Al, Si, Zr, Ti, Fe, Mg, Nb, Ba and V, and a, b, e, d, x and y satisfy the following formulae: 1.9≦(a+b+c+d+y)≦2.1, 1.0<y≦1.3, 0<a≦0.3, 0<b≦0.25, 0.3≦c≦0.7, 0≦d≦0.1, and 1.9≦x≦2.1].

FWHM₀₀₃/FWHM₁₀₄≦0.57 (2)

Any negative electrode active material capable of depositing or intercalating lithium ions can be used as the negative electrode active material used for the negative electrode of the lithium-ion secondary battery. For example, this negative electrode active material includes the following: a titanium-based material such as lithium titanate having a spinel type crystal structure typified by Li[Li_{1/3}Ti_{5/3}]O₄; an alloy-based material lithium metal including Si, Sb, Sn, or the like; a lithium alloy (lithium-silicon, lithium-aluminum, lithium-lead, lithium-tin, lithium-gallium, or a lithium metal-containing alloy such as wood's alloy); a lithium composite oxide (lithium-titanium); and silicon oxide. Further, this negative electrode active material includes an alloy or a carbon material (such as graphite, hard carbon, low-temperature sintered carbon, and amorphous carbon) that can intercalate and deintercalate lithium.

The positive electrode active material layer 14 and the negative electrode active material layer 24 may contain, in addition to the above main constituent components (positive electrode active material and negative electrode active material), for example, a conductive agent and a binder.

The material of the conductive agent is, for example, an electronically conductive material that does not easily adversely affect the battery performance. Examples of the conductive agent include natural graphite (such as scaly graphite, flaky graphite, or amorphous graphite), artificial graphite, carbon black, acetylene black, Ketjen black, a carbon whisker, a carbon fiber, a metal (such as copper, nickel, aluminum, silver, or gold) powder, a metal fiber, and a conductive material such as a conductive ceramic material. Any of these conductive agents may be used alone or in combination of two or more. The amount of the conductive agent added is preferably 0.1 wt. % to 50 wt. %, more preferably 0.5 to 30 wt. %, relative to the total weight of the positive electrode active material layer or the negative electrode active material layer.

As the binder, for example, a single material of, or a mixture including two or more of the following can be used: thermoplastic resins such as polytetrafluoroethylene (PTFE), polyvinylidene fluoride (PVDF), polyethylene, and polypropylene; and rubber-elastic polymers such as ethylene-propylene-diene terpolymer (EPDM), sulfonated EPDM, styrene butadiene rubber (SBR), and fluorine rubber. The amount of the binder added is preferably 1 to 50 wt. %, more preferably 2 to 30 wt. %, relative to the total weight of the positive electrode active material layer or the negative electrode active material layer.

For production of the positive electrode active material layer 14 and the negative electrode active material layer 24, the main constituent component and the other materials are kneaded to provide a mixture. This mixture is further mixed with an organic solvent such as N-methyl-2-pyrrolidone or toluene. The resulting mixture solution is heated at approximately 50° C. to 250° C. for approximately two hours after the solution is applied or pressed onto the current collectors 12 and 22. The positive electrode active material layer 14 and the negative electrode active material layer 24 are thus manufactured suitably. The method of applying the solution includes, for example, a roller coating method using an applicator roll or the like, a screen coating method, a doctor blade method, a spin coating method, or a method using a bar coater. The mixture solution is preferably applied to have an arbitrary thickness and an arbitrary shape by any of these methods. However, the method of applying the solution is not limited to these.

For the current collectors 12 and 22 of the electrodes, iron, copper, stainless steel, nickel, and aluminum can be used. The shape of the current collector may be a sheet, a foam, a mesh, a porous body, an expandable lattice, or the like. Further, a current collector provided with a hole having an arbitrary shape may be used as each of the current collectors 12 and 22.

The nonaqueous electrolyte may be any of materials which have been commonly proposed as those for lithium battery or the like. The nonaqueous electrolyte contains a nonaqueous solvent. Examples of such a nonaqueous electrolyte include: cyclic carbonate esters such as propylene carbonate, ethylene carbonate, butylene carbonate, chloroethylene carbonate, and vinylene carbonate; cyclic esters such as γ-butyrolactone and γ-valerolactone; chain carbonates such as dimethyl carbonate, diethyl carbonate, and ethyl methyl carbonate; chain esters such as methyl formate, methyl acetate, and methyl butyrate; tetrahydrofuran or derivatives thereof; ethers such as 1,3-dioxane, 1,4-dioxane, 1,2-dimethoxyethane, 1,4-dibutoxyethane, and methyl diglyme; nitriles such as acetonitrile and benzonitrile; dioxolane or derivatives thereof; and ethylene sulfide, sulfolane, sultone, or derivatives thereof. Any of these may be used alone or in combination of two or more. The nonaqueous solvent is not limited to these.

Examples of the electrolyte salt in the nonaqueous electrolyte include: an inorganic ion salt containing one kind of lithium (Li), sodium (Na), and potassium (K), such as LiClO₄, LiBF₄, LiAsF₆, LiPF₆, LiSCN, LiBr, LiI, Li₂SO₄, Li₂B₁₀Cl₁₀, NaClO₄, Nal, NaSCN, NaBr, KClO₄ or KSCN; and an organic ion salt such as LiCF₃SO₃, LiN(CF₃SO₂)_{2,} LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phtalate, lithium stearyl sulfonate, lithium octyl sulfonate, or lithium dodecyl benzene sulfonate. Any of these electrolyte salts (ionic compounds) may be used alone or in combination of two or more. In particular, the present active material is difficult to chemically react with the electrolyte salt including F, such as LiBF₄, LiAsF₆, or LiPF₆, and has high durability.

Further, a mixture obtained by mixing LiPF₆ and a lithium salt including a perfluoroalkyl group such as LiN(C₂F₅SO₂)₂ may be used as the electrolyte salt. This can decrease the viscosity of the nonaqueous electrolyte further. Therefore, the low-temperature characteristic of the lithium-ion secondary battery 100 can be further improved. Moreover, the self-discharge of the lithium-ion secondary battery 100 can be suppressed.

The concentration of the electrolyte salt in the nonaqueous electrolyte is preferably 0.1 mol/l to 5 mol/l, and more preferably 0.5 mol/l to 2.5 mol/l. This can surely provide the lithium-ion secondary battery 100 (nonaqueous electrolyte battery) having high battery characteristics.

The description has been made on the nonaqueous electrolyte. Note that the lithium-ion secondary battery 100 may contain an ambient temperature molten salt or ionic liquid. Alternatively, the lithium-ion secondary battery 100 may contain both a nonaqueous electrolyte and a solid electrolyte.

As the separator 18, a porous film or a nonwoven fabric exhibiting an excellent high-rate discharging characteristic is preferably used alone or in combination of two or more kinds thereof. Example of the material used for the separator 18 (separator for the nonaqueous electrolyte battery) include a polyolefin-based resin typified by polyethylene and polypropylene, a polyester-based resin typified by polyethylene terephthalate and polybutylene terephthalate, polyvinylidene fluoride, vinylidene fluoride-hexafluoropropylene copolymer, vinylidene fluoride-perfluorovinylether copolymer, vinylidene fluoride-tetrafluoroethylene copolymer, vinylidene fluoride-trifluoroethylene copolymer, vinylidene fluoride-fluoroethylene copolymer, vinylidene fluoride-hexafluoroacetone copolymer, vinylidene fluoride-ethylene copolymer, vinylidene fluoride-propylene copolymer, vinylidene fluoride-trifluoropropylene copolymer, vinylidene fluoride-tetrafluoroethylene-hexafluoropropylene copolymer, and vinylidene fluoride-ethylene-tetrafluoroethylene copolymer.

From the viewpoint of the charging/discharging characteristic, the porosity of the separator 18 is preferably 20 vol. % or more.

The separator 18 used may be, for example, a polymer gel including the electrolyte and a polymer such as acrylonitrile, ethylene oxide, propylene oxide, methyl methacrylate, vinyl acetate, vinyl pyrrolidone, or polyvinylidene fluoride. The use of the gel-form nonaqueous electrolyte in this structure can suppress the liquid leakage.

The shape of the lithium-ion secondary battery 100 is not limited to the shape depicted in FIG. 1. For example, the shape of the lithium-ion secondary battery 100 may be square, elliptical, coin-like, button-like, or sheet-like.

The present active material can be used also as the electrode material of an electrochemical element other than the lithium-ion secondary battery. Such an electrochemical element includes, for example, a secondary battery such as a metal lithium secondary battery (secondary battery including a positive electrode containing the present active material and a negative electrode containing metal lithium) and an electrochemical capacitor such as a lithium ion capacitor. These electrochemical elements can be used for a power source in self-running micromachines, IC cards, or the like or for a dispersed power source arranged on a printed board or in a printed board.

### EXAMPLES

### Example 1

### [Production of Precursor]

A raw-material mixture containing 37.10 g of lithium acetate dihydrate, 5.28 g of cobalt acetate tetrahydrate, 41.59 g of manganese acetate tetrahydrate, and 12.95 g of nickel acetate tetrahydrate were dissolved in distilled water. Citric acid was added to the resulting solution. The solution was then stirred under heat for 10 hours to allow a reaction to proceed in the solution, thereby providing a first precursor reactant. After that, this first precursor reactant was dried at 120° C. for 24 hours to remove moisture from the first precursor reactant. Subsequently, heat treatment was performed at 500° C. for 5 hours to remove organic components from the first precursor reactant. Consequently, a precursor (brown powder) of Example 1 was obtained. In the raw-material mixture, incidentally, the amounts of lithium acetate dihydrate, nickel acetate tetrahydrate, manganese acetate tetrahydrate, and cobalt acetate tetrahydrate in the raw-material mixture were adjusted to their appropriate amounts, respectively. Thus, the molar numbers of lithium, nickel, cobalt, and manganese in the precursor were adjusted so as to correspond to 0.30 mol of Li_{1.2}Ni_{0.17}Co_{0.07}Mn_{0.56}O₂. In other words, the amounts of the respective hydrates to be mixed (the molar numbers of respective elements) in the raw-material mixture were adjusted so that 0.30 mol of Li_{1.2}Ni_{0.17}Co_{0.07}Mn_{0.56}O₂ could be prepared from the precursor of Example 1. Consequently, the molar number of citric acid added as the complexing agent was set equivalent to the molar number (0.30 mol) of the active material obtained from the precursor of Example 1, or briefly set to 0.30 mol.

### [Production Of Active Material]

The precursor of Example 1 was pulverized for approximately 10 minutes in a mortar. The pulverized precursor was then calcined in the atmospheric air for 10 hours at 950° C., thereby providing the lithium compound (active material) of Example 1. The crystal structure of the active material of Example 1 was analyzed by an X-ray powder diffraction method. The active material of Example 1 was confirmed to have the main phase of the space group R(-3)m structure of a rhombohedral system. Moreover, the diffraction peak peculiar to the space group C2/m structure of a monoclinic crystal system of Li2MnO3 type was observed in the vicinity of 2θ=20 to 25° in the pattern of the X-ray diffraction of the active material of Example 1.

### <Analysis Of Composition>

As a result of composition analysis by an inductively coupled plasma method (ICP method), the composition of the active material of Example 1 was confirmed to be Li_{1.2}Ni_{0.17}Co_{0.07}Mn_{0.56}O₂. It was also confirmed that the molar ratio of the metal elements in the active material of Example 1 was equal to the molar ratio of the metal elements in the precursor of Example 1. In other words, it was confirmed that the composition of the lithium compound (active material) obtained from the precursor can be accurately controlled by adjusting the molar ratio of the metal elements in the precursor.

### <Peak Half Width>

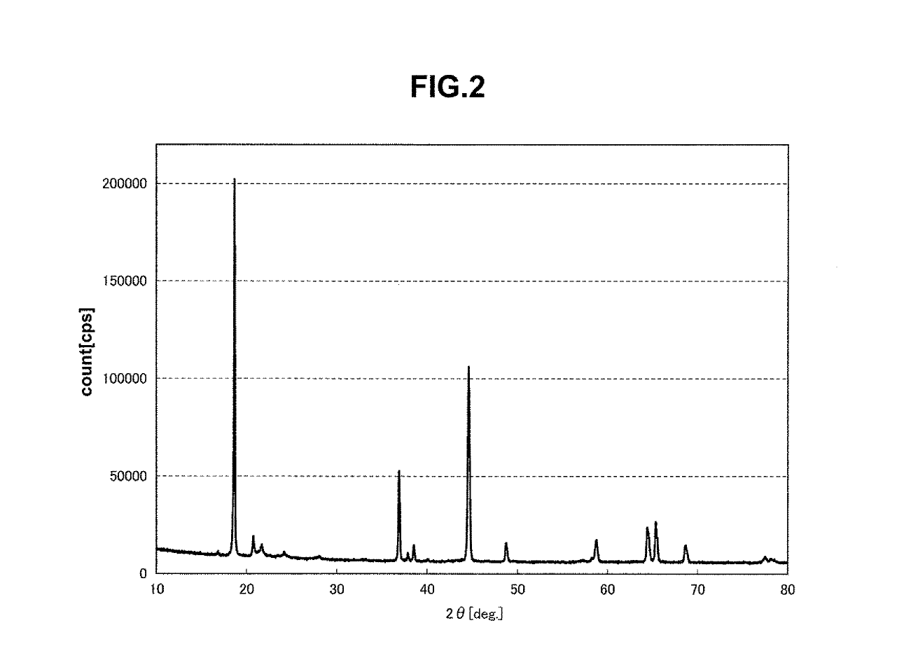

The half width of the peak in the X-ray diffraction of the active material of Example 1 (peak half width) was obtained by the X-ray powder diffraction measurement. In this X-ray powder diffraction measurement, ULTIMA IV manufactured by RIGAKU was used as the X-ray diffraction apparatus. Further, a CuKα tube was used in this measurement. The half width of the diffraction peak at the (003)-plane corresponding to 2θ=18.6°±1° is set as FWHM₀₀₃. The half width of the diffraction peak at the (104)-plane corresponding to 2θ=44.5°±1° is set as FWHM₁₀₄. In this case, FWHM₀₀₃/FWHM₁₀₄ was 0.539. FIG. 2 depicts the X-ray diffraction patterns of the active material of Example 1.

### <Primary Particle Diameter>

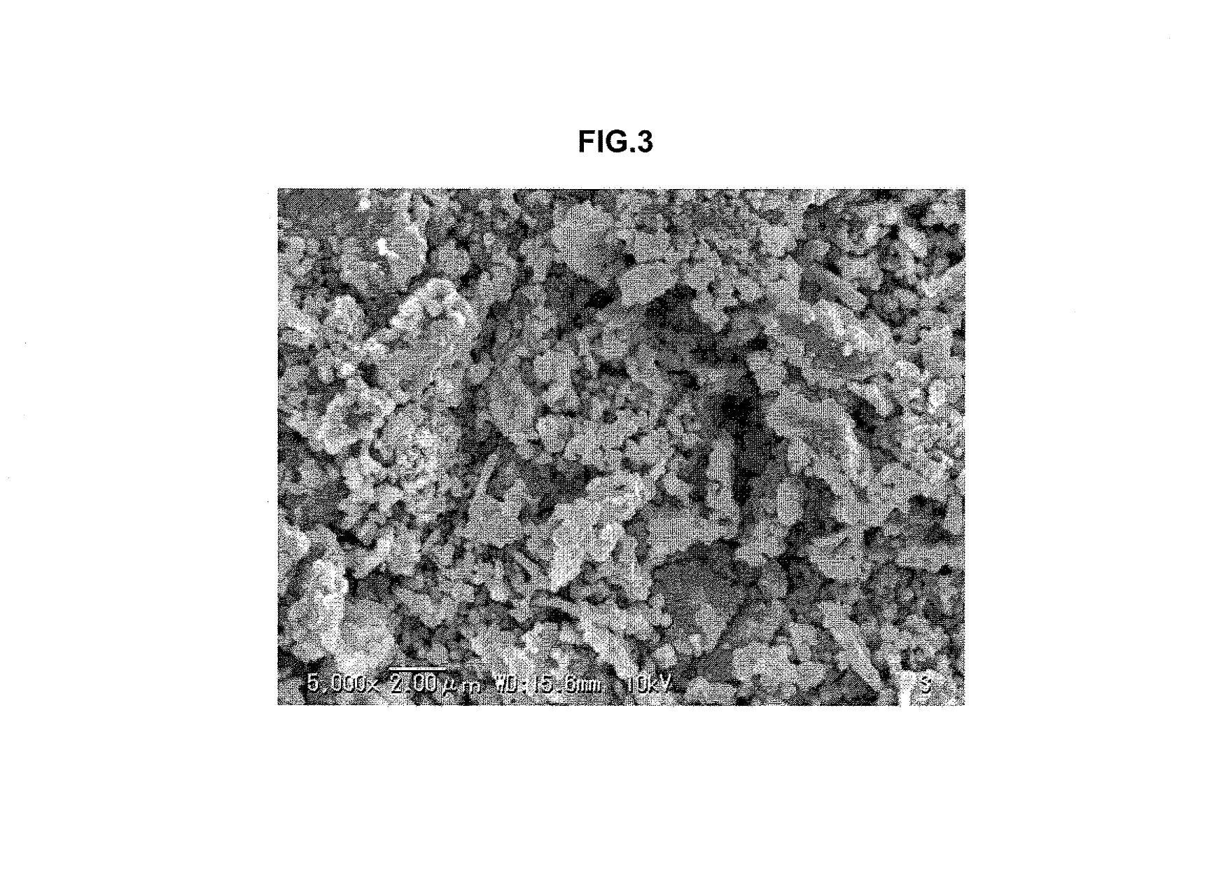

The active material of Example 1 was observed with a scanning electron microscope (SEM). Thus, 500 or more primary particles were photographed. Based on the obtained images, the area of each particle was calculated. Then, the results of calculation were converted into diameters of equivalent circles, thereby leading the particle diameters. The average value of the particle diameters was taken as the primary particle diameter. As a result, the primary particle diameter of the active material of Example 1 was 0.31 μm. FIG. 3 is a SEM image of the powder of the active material of Example 1.

### [Production Of Positive Electrode]

A coating for the positive electrode was prepared by mixing the active material of Example 1, a conductive auxiliary agent, and a solvent including a binder. This coating for the positive electrode was applied to an aluminum foil (thickness: 20 μm) as a positive electrode current collector by a doctor blade method. Then, the positive electrode current collector was dried at 100° C. and rolled. Thus, the positive electrode including the layer of the active material of Example 1 (positive electrode active material layer) and the positive electrode current collector was obtained. As the conductive auxiliary agent, carbon black and graphite were used. As the solvent including the binder, N-methyl-2-pyrrolidinone in which PVDF was dissolved was used.

### [Production Of Negative Electrode]

A coating for the negative electrode was prepared by a method similar to the method for forming the coating for the positive electrode except that natural graphite was used instead of the active material of Example 1 and that only carbon black was used as the conductive auxiliary agent. This coating for the negative electrode was applied to a copper foil (thickness: 16 run) as a negative electrode current collector by a doctor blade method. After that, the negative electrode current collector was dried at 100° C. and rolled. This provided the negative electrode having the negative electrode active material layer and the negative electrode current collector.

### [Production Of Lithium-Ion Secondary Battery]

The positive electrode and the negative electrode produced as above, and the separator (microporous film made of polyolefin) were cut into predetermined dimensions. The positive electrode and the negative electrode each had a portion where the coating for the electrode was not applied, so that the portion is used for welding an external leading-out terminal as a positive electrode lead or a negative electrode lead. The positive electrode, the negative electrode, and the separator were stacked in this order. For stacking the positive electrode, the negative electrode, and the separator while avoiding the displacement from one another, these were fixed by applying a small amount of hot-melt adhesive (ethylene-methacrylic acid copolymer, EMAA) thereto. To the positive electrode and the negative electrode, an aluminum foil (with a width of 4 mm, a length of 40 mm, and a thickness of 100 μm) and a nickel foil (with a width of 4 mm, a length of 40 mm, and a thickness of 100 μm) were welded with ultrasonic waves as the external leading-out terminals, respectively. Around each external leading-out terminal, polypropylene (PP) as grafted maleic anhydride was wound and thermally adhered. This polypropylene is to improve the sealing property between the external terminal and an exterior body. A battery exterior body (case) for sealing the battery element including the positive electrode, the negative electrode, and the separator which were stacked was prepared. As the material of this battery exterior body, an aluminum laminated material including a PET layer, an Al layer, and a PP layer was used. The thicknesses of the PET layer, the Al layer, and the PP layer were 12 μm, 40 μm, and 50 μm, respectively. Note that PET stands for polyethylene terephthalate and PP stands for polypropylene. Among the three layers above, the PP layer is disposed at the innermost position in the battery exterior body. Into this exterior body, the battery element was put and an appropriate amount of electrolyte solution was added. Then, the exterior body was sealed to vacuum. Thus, the lithium-ion secondary battery containing the active material according to Example 1 was produced. As the electrolyte solution (solution of electrolyte), a mixed solvent including ethylene carbonate (EC) and dimethylcarbonate (DMC), in which 1 M (1 mol/L) LiPF₆ was dissolved, was used. The volume ratio between EC and DMC in the mixed solvent was EC:DMC=30:70.

### [Measurement Of Electric Characteristic]

The obtained lithium-ion secondary battery (lithium-ion secondary battery of Example 1) was charged at a constant current up to 4.8 V. The current value at this charging was 30 mA/g. Then, this battery was discharged at a constant current down to 2.0 V. The current value at this discharging was 30 mA/g. The initial discharge capacity of this secondary battery was 215 mAh/g. A cycle test was performed in which this charging/discharging cycle was repeated 50 times. The test was performed at 25° C. When the initial discharge capacity of the lithium-ion secondary battery of Example 1 was assumed 100%, the discharge capacity thereof after 50 cycles was 90%. The proportion (percentage) of the discharge capacity after the 50 cycles relative to the initial discharge capacity is called a cycle characteristic below. The initial discharge capacity corresponds to the capacity at the first charging time. A high cycle characteristic represents the excellent charging/discharging cycle durability of the battery.

### Examples 2 to 6, and Comparative Examples 1 to 3

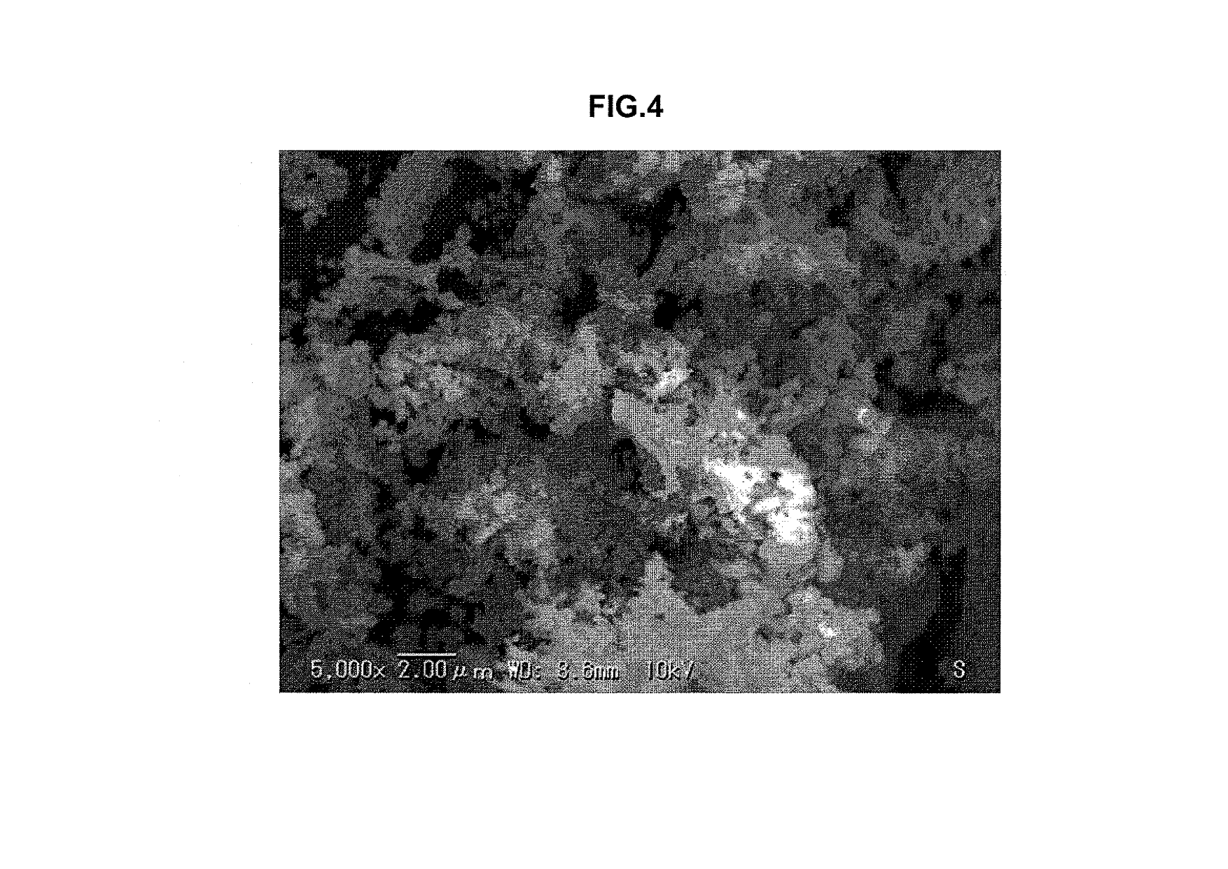

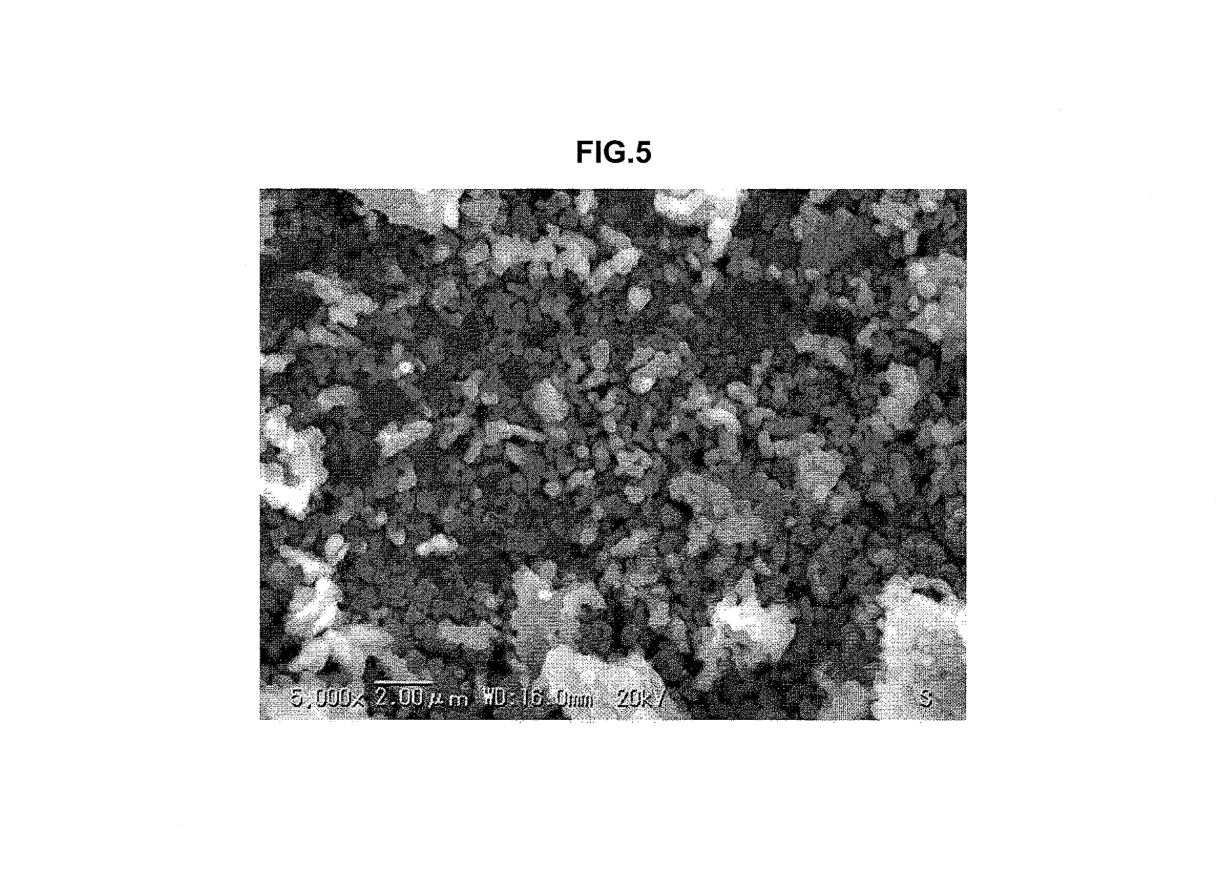

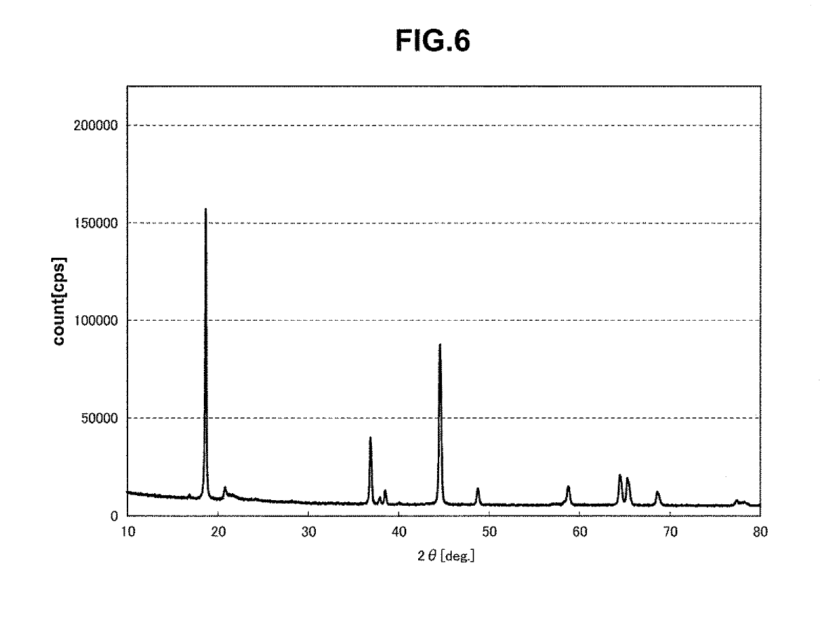

The lithium compounds (active materials) of Examples 2 to 6 and Comparative Examples 1 to 3 were produced in a manner similar to Example 1 except that the calcining condition for the precursor was adjusted. In Example 2, the active material was obtained by calcining the precursor at 850° C. for 10 hours. In Example 3, the active material was obtained by calcining the precursor at 1050° C. for 10 hours. In Example 4, the active material was obtained by calcining the precursor at 800° C. for 10 hours. In Example 5, the active material was obtained by calcining the precursor at 850° C. for 5 hours. In Example 6, the active material was obtained by calcining the precursor at 1100° C. for 10 hours. In Comparative Example 1, the active material was obtained by calcining the precursor at 750° C. for 10 hours. FIG. 4 is a SEM image of the powder of the active material of Comparative Example 1. In Comparative Example 2, the active material was obtained by calcining the precursor at 1150° C. for 10 hours. FIG. 5 is a SEM image of the powder of the active material of Comparative Example 2. In Comparative Example 3, the active material was obtained by calcining the precursor at 950° C. for 2 hours. FIG. 6 depicts the X-ray diffraction pattern of the active material of Comparative Example 3.

### Example 7 and Comparative Example 4

The lithium compounds (active materials) of Example 7 and Comparative Example 4 were produced in a manner similar to Example 1 except that the pulverization was performed using a ball mill after the precursor was calcined. This pulverization is a factor that affects the peak half width and the primary particle diameter. In Example 7, the precursor was calcined at 1050° C. for 10 hours. After that, the calcined precursor was subjected to planetary ball mill treatment for one minute at a rotation number of 500 rpm three times. In Comparative Example 4, the precursor was calcined at 1050° C. for 10 hours. After that, the calcined precursor was subjected to planetary ball mill treatment for one minute at a rotation number of 500 rpm ten times.

### Examples 8 to 13 and Comparative Examples 5 and 6

The lithium compounds (active materials) of Examples 8 to 13 and Comparative Examples 5 and 6 were produced in a manner similar to Example 1 except that the amounts of a cobalt source, a nickel source, and a manganese source of the raw-material mixture of the precursor were adjusted.

### Examples 14 to 22

The lithium compounds (active materials) of Examples 14 to 22 were produced in a manner similar to Example 1 except that the composition of the raw-material mixture of the precursor was changed. In other words, in Example 14, aluminum nitrate nonahydrate (Al source) was added as the source of M represented by (1) to the raw-material mixture of the precursor. In Example 15, vanadium oxide (V source) was added as the source of M to the raw-material mixture of the precursor. In Example 16, silicon dioxide (Si source) was added as the source of M to the raw-material mixture of the precursor. In Example 17, magnesium nitrate hexahydrate (Mg source) was added as the source of M to the raw-material mixture of the precursor. In Example 18, zirconium nitrate oxide dihydrate (Zr source) was added as the source of M to the raw-material mixture of the precursor. In Example 19, titanium sulfate hydrate (Ti source) was added as the source of M to the raw-material mixture of the precursor. In Example 20, iron sulfate heptahydrate (Fe source) was added as the source of M to the raw-material mixture of the precursor. In Example 21, barium carbonate (Ba source) was added as the source of M to the raw-material mixture of the precursor. In Example 22, niobium oxide (Nb source) was added as the source of M to the raw-material mixture of the precursor.

The initial discharge capacity and the cycle characteristic of the batteries containing the active materials of Examples 2 to 22 and Comparative Examples 1 to 6 were evaluated in a manner similar to Example 1. The results are shown in Table 1. In Table 1 below, a battery having an initial discharge capacity of 190 mAh/g or more and a cycle characteristic of 85% or more is evaluated as “A”. A battery having an initial discharge capacity of less than 190 mAh/g and a battery having a cycle characteristic of less than 85% are evaluated as “F”.

TABLE 1

| | | | primary | initial | | |
|---|---|---|---|---|---|---|
| | lithium compound (active material) | peak half width ratio | particle | discharge | cycle | |
| | composition formula | FWHM₀₀₃/FWHM₁₀₄ | diameter | capacity | characteristic | |
| | Li_{y}NiₐCo_{b}Mn_{c}M_{d}Ox | — | μm | mAh/g | % | evaluation |
| Example 1 | Li_{1.2}Ni_{0.17}Co_{0.07}Mn_{0.56}O_{2.0} | 0.539 | 0.31 | 215 | 90 | A |
| Example 2 | Li_{1.2}Ni_{0.17}Co_{0.07}Mn_{0.56}O_{2.0} | 0.551 | 0.25 | 220 | 88 | A |
| Example 3 | Li_{1.2}Ni_{0.17}Co_{0.07}Mn_{0.56}O_{2.0} | 0.525 | 0.43 | 206 | 95 | A |
| Example 4 | Li_{1.2}Ni_{0.17}Co_{0.07}Mn_{0.56}O_{2.0} | 0.570 | 0.22 | 224 | 86 | A |
| Comparative | Li_{1.2}Ni_{0.17}Co_{0.07}Mn_{0.56}O_{2.0} | 0.565 | 0.16 | 228 | 72 | F |
| Example 1 | | | | | | |
| Example 5 | Li_{1.2}Ni_{0.17}Co_{0.07}Mn_{0.56}O_{2.0} | 0.561 | 0.20 | 222 | 86 | A |
| Example 6 | Li_{1.2}Ni_{0.17}Co_{0.07}Mn_{0.56}O_{2.0} | 0.511 | 0.50 | 191 | 97 | A |
| Comparative | Li_{1.2}Ni_{0.17}Co_{0.07}Mn_{0.56}O_{2.0} | 0.449 | 0.59 | 150 | 98 | F |
| Example 2 | | | | | | |
| Comparative | Li_{1.2}Ni_{0.17}Co_{0.07}Mn_{0.56}O_{2.0} | 0.584 | 0.27 | 180 | 60 | F |
| Example 3 | | | | | | |
| Example 7 | Li_{1.2}Ni_{0.17}Co_{0.07}Mn_{0.56}O_{2.0} | 0.548 | 0.28 | 216 | 89 | A |
| Comparative | Li_{1.2}Ni_{0.17}Co_{0.07}Mn_{0.56}O_{2.0} | 0.594 | 0.23 | 225 | 76 | F |
| Example 4 | | | | | | |
| Example 8 | Li_{1.2}Ni_{0.17}Co_{0.03}Mn_{0.60}O_{2.0} | 0.545 | 0.33 | 215 | 89 | A |
| Example 9 | Li_{1.2}Ni_{0.10}Co_{0.14}Mn_{0.56}O_{2.0} | 0.542 | 0.32 | 214 | 90 | A |
| Example 10 | Li_{1.2}Ni_{0.25}Co_{0.07}Mn_{0.48}O_{2.0} | 0.558 | 0.29 | 210 | 91 | A |
| Example 11 | Li_{1.2}Ni_{0.11}Co_{0.07}Mn_{0.62}O_{2.0} | 0.541 | 0.34 | 216 | 87 | A |
| Example 12 | Li_{1.2}Ni_{0.17}Co_{0.15}Mn_{0.48}O_{2.0} | 0.536 | 0.35 | 203 | 92 | A |
| Example 13 | Li_{1.2}Ni_{0.21}Co_{0.03}Mn_{0.56}O_{2.0} | 0.544 | 0.29 | 213 | 92 | A |
| Comparative | Li_{1.2}Ni_{0.10}Co_{0.30}Mn_{0.40}O_{2.0} | 0.553 | 0.38 | 205 | 81 | F |
| Example 5 | | | | | | |
| Comparative | Li_{1.2}Co_{0.30}Mn_{0.50}O_{2.0} | 0.541 | 0.42 | 175 | 82 | F |
| Example 6 | | | | | | |
| Example 14 | Li_{1.2}Ni_{0.17}Co_{0.07}Mn_{0.55}Al_{0.01}O_{2.0} | 0.537 | 0.32 | 212 | 92 | A |
| Example 15 | Li_{1.2}Ni_{0.17}Co_{0.07}Mn_{0.55}V_{0.01}O_{2.0} | 0.539 | 0.31 | 217 | 95 | A |
| Example 16 | Li_{1.2}Ni_{0.17}Co_{0.07}Mn_{0.55}Si_{0.01}O_{2.0} | 0.540 | 0.29 | 210 | 91 | A |
| Example 17 | Li_{1.2}Ni_{0.17}Co_{0.07}Mn_{0.55}Mg_{0.01}O_{2.0} | 0.539 | 0.29 | 210 | 90 | A |
| Example 18 | Li_{1.2}Ni_{0.17}Co_{0.07}Mn_{0.55}Zr_{0.01}O_{2.0} | 0.541 | 0.33 | 211 | 91 | A |
| Example 19 | Li_{1.2}Ni_{0.17}Co_{0.07}Mn_{0.55}Ti_{0.01}O_{2.0} | 0.541 | 0.29 | 209 | 89 | A |
| Example 20 | Li_{1.2}Ni_{0.17}Co_{0.07}Mn_{0.55}Fe_{0.01}O_{2.0} | 0.537 | 0.32 | 218 | 95 | A |
| Example 21 | Li_{1.2}Ni_{0.17}Co_{0.07}Mn_{0.55}Ba_{0.01}O_{2.0} | 0.542 | 0.31 | 208 | 90 | A |
| Example 22 | Li_{1.2}Ni_{0.17}Co_{0.07}Mn_{0.55}Nb_{0.01}O_{2.0} | 0.543 | 0.30 | 211 | 89 | A |

The compositions of the active materials of examples and comparative examples are shown in Table 1. It was confirmed that the compositions of Examples 1 to 22 and Comparative Examples 1 to 4 satisfied the following formula (1):

Li_{y}NiₐCo_{b}Mn_{c}M_{d}Oₓ (1)

[wherein the element M is at least one element selected from the group consisting of Al, Si, Zr, Ti, Fe, Mg, Nb, Ba and V, and a, b, c, d, x and y satisfy the following formulae: 1.9≦(a+b+e+d+y)≦2.1, 1.0<y≦1.3, 0<a≦0.3, 0<b≦0.25, 0.3≦c≦0.7, 0≦d≦0.1, and 1.9≦x≦2.1].

The peak half width ratios of the active materials of examples and comparative examples (FWHM₀₀₃/FWHM₁₀₄) are shown Table 1. It was confirmed that Examples 1 to 22 and Comparative Examples 1, 2, 5, and 6 satisfied the following formula (2):

FWHM₀₀₃/FWHM₁₀₄≦0.57 (2)

Meanwhile, it was confirmed that neither Comparative Example 3 nor Comparative Example 4 satisfied the formula (2).

The primary particle diameters of the active materials of examples and comparative examples are shown in Table 1. It was confirmed that the primary particle diameters of Examples 1 to 22 and Comparative Examples 3 to 6 were within the range of 0.2 to 0.5 μm. Meanwhile, it was confirmed that the primary particle diameters of Comparative Examples 1 and 2 were not in the range of 0.2 to 0.5 μm, as shown in Table 1.

The initial discharge capacity and the cycle characteristic of each of the batteries containing the active materials of Examples 1 to 22 are shown in Table 1. In any battery, it was confirmed that the discharge capacity was 190 mAh/g or more and the cycle characteristic was 85% or more.

The initial discharge capacity and the cycle characteristic of each of the batteries containing the active materials of Comparative Examples 1 to 6 are shown in Table 1. In any battery, it was confirmed that the discharge capacity was less than 190 mAh/g or the cycle characteristic was less than 85%. The active material according to the present disclosure may be a first active material described below. The first active material has a layered structure and has a composition represented by the formula (1) below, and the ratio of the half width FWHM₀₀₃ of the diffraction peak at the (003)-plane to the half width FWHM₁₀₄ of the diffraction peak at the (104)-plane in the X-ray powder diffraction diagram is represented by the formula (2) below, and the primary particle diameter is in the range of 0.2 μm to 0.5 μm.

Li_{y}NiₐCo_{b}Mn_{c}M_{d}Oₓ (1)

[wherein the element M is at least one element selected from the group consisting of Al, Si, Zr, Ti, Fe, Mg, Nb, Ba and V, and a, b, c, d, x and y satisfy the following formulae: 1.9≦(1+b+c+d+y)≦2.1, 1.0<y≦1.3, 0<a≦0.3, 0<b≦0.25, 0.3≦c≦0.7, 0≦d≦0.1, and 1.9≦x≦2.1].

FWHM₀₀₃/FWHM₁₀₄≦0.57 (2)

The relation of FWHM₀₀₃/FWHM₁₀₄ represents the thickness of the active material with the layered structure in the c-axis direction. When FWHM₀₀₃<FWHM₁₀₄ holds, that is, as the value of FWHM₀₀₃ is smaller, the thickness of the crystal of the active material in the c-axis direction is larger. Meanwhile, the primary particle diameter of the active material is closely related to the capacity of the battery.

The positive electrode material of the present disclosure is thicker along the c-axis direction and the intercalation and deintercalation of lithium with respect to the active material are performed smoothly. Moreover, the primary particle diameter is small and the surface area of the primary particle is large. Accordingly, the positive electrode material of the present disclosure has a high discharge capacity and an excellent cycle characteristic.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An active material comprising a layered structure and a composition represented by the formula (1) below, the active material having:
a ratio of a half width FWHM₀₀₃ of a diffraction peak at a (003)-plane to a half width FWHM₁₀₄ of a diffraction peak at a (104)-plane represented by the formula (2) below, where both the peaks are obtained by X-ray powder diffraction; and
an average primary particle diameter of 0.2 μm to 0.5 μm.
Li_{y}NiₐCo_{b}Mn_{c}M_{d}Oₓ (1)
[wherein the element M is at least one element selected from the group consisting of Al, Si, Zr, Ti, Fe, Mg, Nb, Ba and V, and a, b, c, d, x and y satisfy the following formulae: 1.9≦(a+b+c+d+y)≦2.1, 1.0<y≦1.3, 0<a≦0.3, 0<b≦0.25, 0.3≦c≦0.7, 0<d≦0.1, and 1.9≦x≦2.1], and
FWHM₀₀₃/FWHM₁₀₄≦0.57 (2).

2. The active material according to claim 1, wherein the element M of the formula (1) is Fe or V and d satisfies 0<d≦0.1.

3. The active material according to claim 1, wherein the half width FWHM₀₀₃ of the diffraction peak at the (003)-plane is 0.13 or less.

4. The active material according to claim 3, wherein the half width FWHM₁₀₄ of the diffraction peak at the (104)-plane is 0.20 or less.

5. The active material according to claim 4, further having a half width FWHM010 of a diffraction peak at a (010)-plane of 0.15 or less, where the peak is obtained by X-ray powder diffraction.

6. The active material according to claim 2, wherein the half width FWHM₀₀₃ of the diffraction peak at the (003)-plane is 0.13 or less.

7. The active material according to claim 6, wherein the half width FWHM₁₀₄ of the diffraction peak at the (104)-plane is 0.20 or less.

8. The active material according to claim 7, further having a half width FWHM₀₁₀ of a diffraction peak at a (010)-plane of 0.15 or less, where the peak is obtained by X-ray powder diffraction.

9. The active material according to claim 1, wherein the average primary particle diameter is in the range of 0.3 to 0.4 μm.

10. The active material according to claim 2, wherein the average primary particle diameter is in the range of 0.3 to 0.4 μm.

11. The active material according to claim 5, wherein the average primary particle diameter is in the range of 0.3 to 0.4 μm.

12. The active material according to claim 8, wherein the average primary particle diameter is in the range of 0.3 to 0.4 μm.

13. A lithium-ion secondary battery comprising:
a positive electrode including a positive electrode current collector and a positive electrode active material layer containing a positive electrode active material;
a negative electrode including a negative electrode current collector and a negative electrode active material layer containing a negative electrode active material;
a separator disposed between the positive electrode active material layer and the negative electrode active material layer; and
an electrolyte in contact with the negative electrode, the positive electrode, and the separator, wherein:
the positive electrode active material contains the active material according to claim 1.

14. A lithium-ion secondary battery comprising:
a positive electrode including a positive electrode current collector and a positive electrode active material layer containing a positive electrode active material;
a negative electrode including a negative electrode current collector and a negative electrode active material layer containing a negative electrode active material;
a separator disposed between the positive electrode active material layer and the negative electrode active material layer; and
an electrolyte in contact with the negative electrode, the positive electrode, and the separator, wherein:
the positive electrode active material contains the active material according to claim 2.

15. A lithium-ion secondary battery comprising:
a positive electrode including a positive electrode current collector and a positive electrode active material layer containing a positive electrode active material;
a negative electrode including a negative electrode current collector and a negative electrode active material layer containing a negative electrode active material;
a separator disposed between the positive electrode active material layer and the negative electrode active material layer; and
an electrolyte in contact with the negative electrode, the positive electrode, and the separator, wherein:
the positive electrode active material contains the active material according to claim 5.

16. A lithium-ion secondary battery comprising:
a positive electrode including a positive electrode current collector and a positive electrode active material layer containing a positive electrode active material;
a negative electrode including a negative electrode current collector and a negative electrode active material layer containing a negative electrode active material;
a separator disposed between the positive electrode active material layer and the negative electrode active material layer; and
an electrolyte in contact with the negative electrode, the positive electrode, and the separator, wherein:
the positive electrode active material contains the active material according to claim 8.

17. A lithium-ion secondary battery comprising:
a positive electrode including a positive electrode current collector and a positive electrode active material layer containing a positive electrode active material;
a negative electrode including a negative electrode current collector and a negative electrode active material layer containing a negative electrode active material;
a separator disposed between the positive electrode active material layer and the negative electrode active material layer; and
an electrolyte in contact with the negative electrode, the positive electrode, and the separator, wherein:
the positive electrode active material contains the active material according to claim 12.
